(19) United States
(12) Patent Application Publication
(10) Pub. No.: US 2026/0180211 A1
(43) Pub. Date: Jun. 25, 2026

(54) BUS BAR

(71) Applicant: YAZAKI CORPORATION, Tokyo (JP)

(72) Inventors: Mariko Nakagawa, Makinohara-shi (JP); Tatsuya Oga, Makinohara-shi (JP); Katsunori Sato, Makinohara-shi (JP); Seigo Mochizuki, Fujieda-shi (JP)

(21) Appl. No.: 19/363,559

(22) Filed: Oct. 20, 2025

(30) Foreign Application Priority Data
Oct. 22, 2024 (JP) 2024-185746

(51) Int. Cl. H01R 4/58; H01B 5/00; H01M 50/503; H01M 50/505

(52) U.S. Cl. CPC H01R 4/58; H01B 5/002; H01M 50/503; H01M 50/505

(57) ABSTRACT

A bus bar includes a conductor that connects electrodes of two battery cells. The conductor has two fixed parts and a plurality of slits that extend in a first direction. The slits are arranged along a second direction. One of the fixed parts is disposed on one side in the first direction with respect to the slits. Another fixed part is disposed on another side in the first direction with respect to the slits. The slits include one first slit, and a second slit placed further away from a virtual line that connects the two fixed parts than the first slit. Length of the second slit along the first direction is greater than length of the first slit along the first direction.

### CROSS-REFERENCE TO RELATED APPLICATION(S)

The present application claims priority to and incorporates by reference the entire contents of Japanese Patent Application No. 2024-185746 filed in Japan on Oct. 22, 2024.

### BACKGROUND OF THE INVENTION

### 1. Field of the Invention

The present invention relates to a bus bar.

### 2. Description of the Related Art

Conventionally, there is a bus bar that connects different members. Japanese Patent Application Laid-open No. 2022-007032 (JP 2022-007 032 A) discloses the technology of a bus bar that links a plurality of terminals, and that is provided with a plurality of slits extending in the length direction of the bus bar and that are arranged side by side in the width direction of the bus bar orthogonal to the length direction.

Japanese Patent Application Laid-open No. 2017-216095 (JP 2017-216 095 A) discloses a battery module including a bus bar. In this battery module, the bus bar has a connection part connected to an external terminal of one battery cell and a connection part connected to an external terminal of another battery cell, and a fragile part whose compressive strength in a direction toward which the battery cells are stacked is smaller than that of the connection parts, is disposed between the two connection parts.

There is room for improvement in terms of reducing the stress concentration in a bus bar. For example, a bus bar fixed to two battery cells is deformed depending on the relative movement of the battery cells. When there are a plurality of slits on the bus bar, it is preferable to reduce the stress concentration that occurs when the bus bar is deformed.

### SUMMARY OF THE INVENTION

An object of the present invention is to provide a bus bar that can reduce stress concentration when there are a plurality of slits.

In order to achieve the above mentioned object, a bus bar according to one aspect of the present invention includes a plate-shaped conductor that connects electrodes of two battery cells, wherein the conductor has two fixed parts each fixed to the electrode of a different battery cell, and a plurality of slits that extend in a first direction, the slits are arranged along a second direction orthogonal to the first direction, one of the fixed parts is disposed on one side in the first direction with respect to the slits, another fixed part is disposed on another side in the first direction with respect to the slits, the slits include one first slit, and a second slit placed further away from a virtual line that connects the two fixed parts than the first slit, and length of the second slit along the first direction is greater than length of the first slit along the first direction.

### BRIEF DESCRIPTION OF THE DRAWINGS

FIG. 1 is a plan view of a bus bar and a battery pack according to an embodiment.

FIG. 2 is a plan view of the bus bar according to the embodiment.

FIG. 3 is a perspective view of the bus bar according to the embodiment.

FIG. 4 is a plan view of the bus bar according to the embodiment.

FIG. 5 is a plan view of a bus bar according to a comparative example.

FIG. 6 is a plan view of another bus bar according to the embodiment.

FIG. 7 is a plan view of another bus bar according to the embodiment.

FIG. 8 is a plan view of another bus bar according to the embodiment.

### DETAILED DESCRIPTION OF THE PREFERRED EMBODIMENTS

Hereinafter, a bus bar according to an embodiment of the present invention will be described in detail with reference to the drawings. However, the invention is not limited to this embodiment. Moreover, components in the following embodiment include those that can be easily assumed by those skilled in the art or those that are substantially the same.

### Embodiment

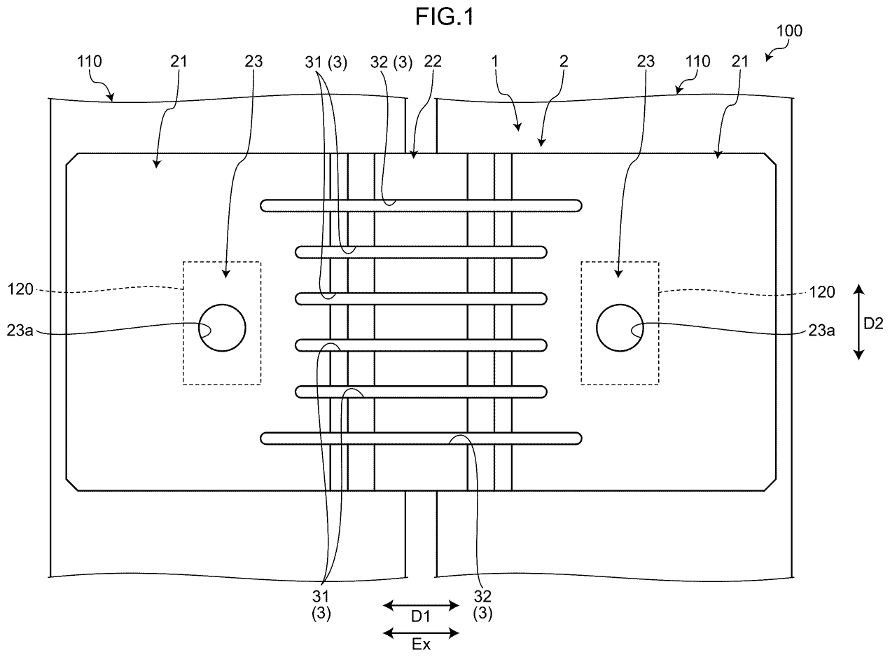

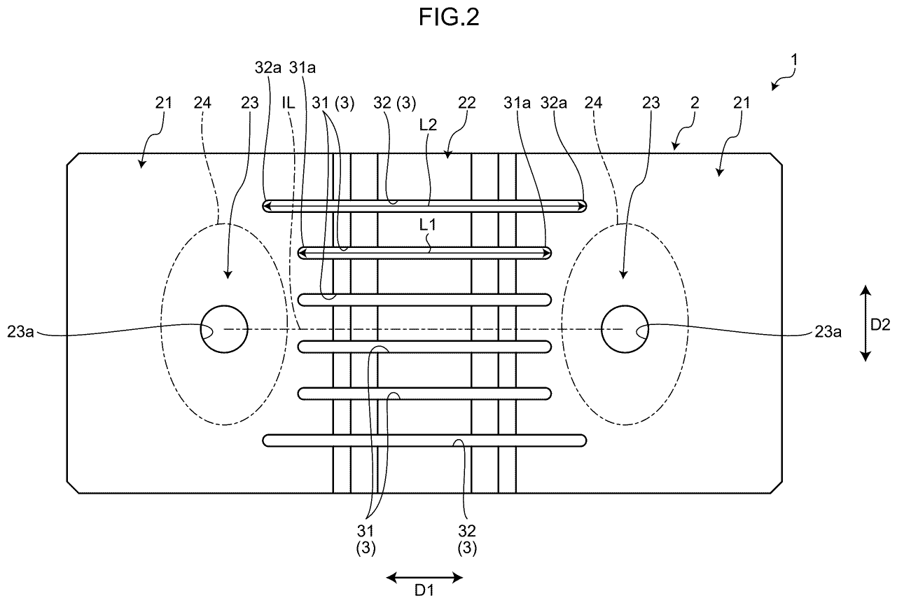

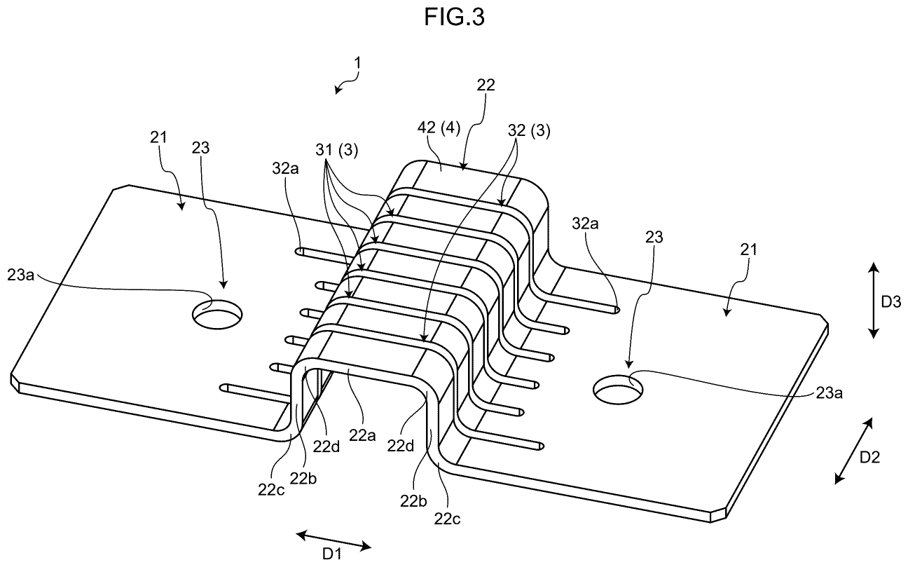

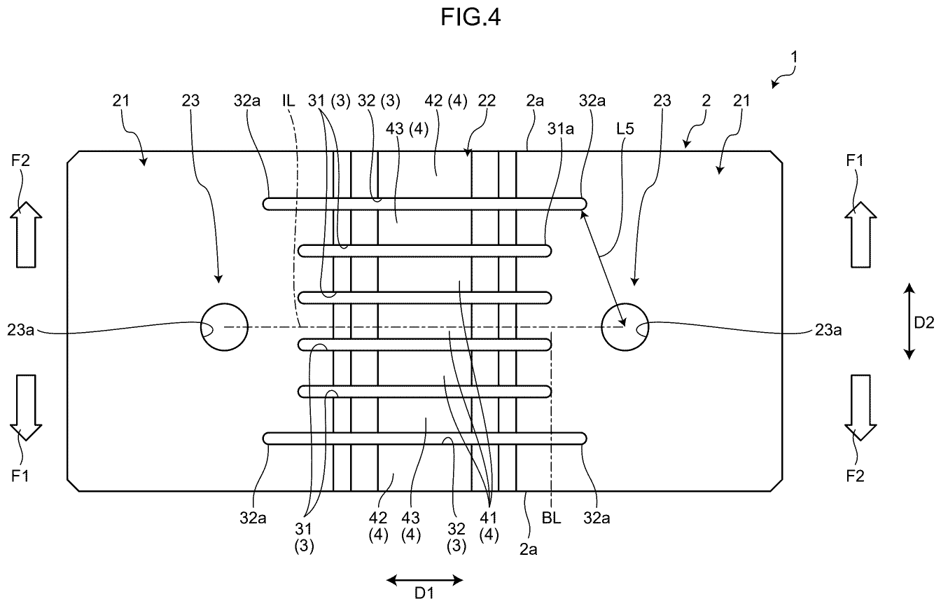

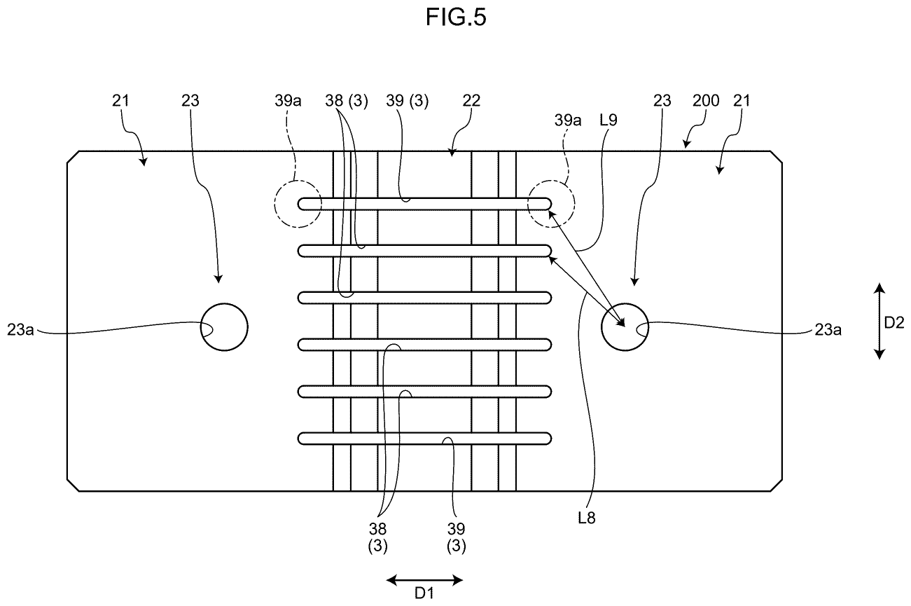

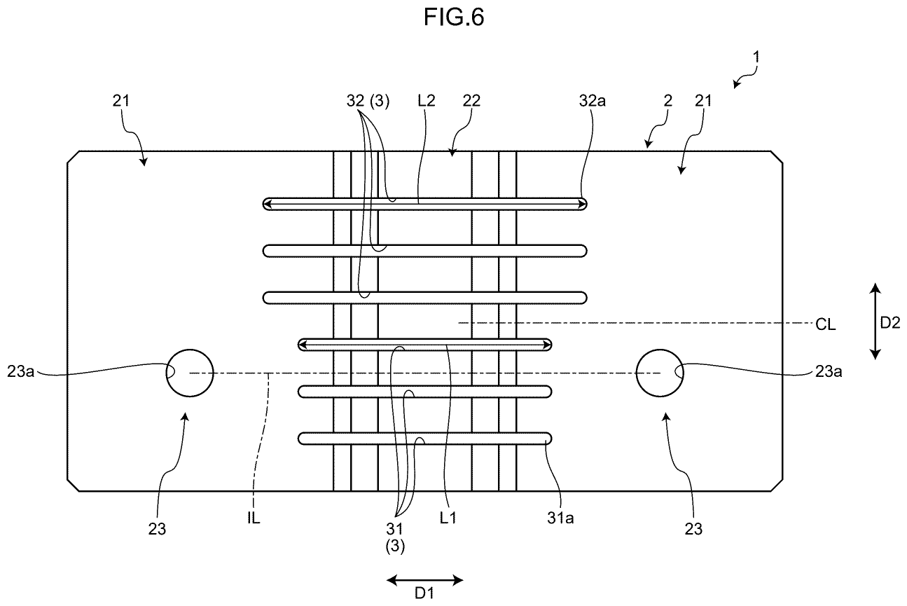

With reference to FIG. 1 to FIG. 8, an embodiment will be described. The present embodiment relates to a bus bar. FIG. 1 is a plan view of a bus bar and a battery pack according to an embodiment. FIG. 2 is a plan view of the bus bar according to the embodiment. FIG. 3 is a perspective view of the bus bar according to the embodiment. FIG. 4 is a plan view of the bus bar according to the embodiment. FIG. 5 is a plan view of a bus bar according to a comparative example. FIG. 6 to FIG. 8 are each a plan view of another bus bar according to the embodiment.

As illustrated in FIG. 1, a bus bar 1 of the present embodiment is a conductive member that connects electrodes 120 of two adjacent battery cells 110 to each other. The illustrated battery cell 110 forms a battery pack 100 to be mounted on a vehicle. The battery pack 100 is the power source of a vehicle, and is mounted on an electric vehicle (BEV), a hybrid electric vehicle (HEV), a plug-in hybrid electric vehicle (PHEV), and the like. The battery pack 100 includes a plurality of the battery cells 110 disposed side by side along an arranging direction Ex. The battery pack 100 may also include a plurality of battery modules including the battery cells 110.

The bus bar 1 connects the electrode 120 of one of the two adjacent battery cells 110 with the electrode 120 of the other. As illustrated in FIG. 1 to FIG. 3, the bus bar 1 includes a plate-shaped conductor 2. The conductor 2 electrically connects the electrodes 120 of the two battery cells 110. For example, the conductor 2 is formed of a metal plate having conductivity. The bus bar 1 may also include other elements in addition to the conductor 2. For example, the bus bar 1 may also include a terminal part to which a detection line to detect voltage is connected.

The illustrated conductor 2 has a rectangular shape in a plan view. The conductor 2 has two fixed parts 23. The fixed part 23 is a portion fixed to the electrode 120 of the battery cell 110. For example, the fixed part 23 is fixed to the electrode 120 by welding, such as laser welding. A welding range 24 illustrated in FIG. 2 is set for each of the fixed parts 23. At least a part of the welding range 24 is welded to the electrode 120, and is fixed to the electrode 120.

The fixed part 23 of the present embodiment has a through hole 23a. The through hole 23a penetrates through the conductor 2 along the thickness direction of the conductor 2. The shape of the illustrated through hole 23a is a circular shape. For example, the position of the through hole 23a is the center of the fixed part 23. The illustrated welding range 24 is set around the through hole 23a. The shape of the illustrated welding range 24 is an oval shape concentric with the through hole 23a. The shape of the through hole 23a is not limited to a circular shape. Moreover, the fixed part 23 may not have the through hole 23a.

The two fixed parts 23 are disposed at an interval. For example, the interval between the two fixed parts 23 is defined according to the relative positions of the two adjacent electrodes 120. As illustrated in FIG. 2, the conductor 2 has a first direction D1 and a second direction D2. The first direction D1 is a direction toward which the two fixed parts 23 are arranged side by side. In the illustrated conductor 2, the two fixed parts 23 are disposed side by side along the longitudinal direction of the conductor 2. As illustrated in FIG. 1, the bus bar 1 is fixed to the battery cell 110 so that the two fixed parts 23 are arranged side by side along the arranging direction Ex. In other words, when the bus bar 1 is fixed to the two battery cells 110, the first direction D1 extends along the arranging direction Ex.

The second direction D2 is a direction orthogonal to the first direction D1, and is orthogonal to the first direction D1 when the conductor 2 is viewed in a plan view. In the illustrated conductor 2, the second direction D2 is the width direction of the conductor 2. As illustrated in FIG. 3, the conductor 2 has a third direction D3. The third direction D3 is orthogonal to the first direction D1 and the second direction D2. The through hole 23a penetrates through the conductor 2 along the third direction D3.

The conductor 2 has two flat-shaped end regions 21 and one intermediate region 22. The two end regions 21 and the intermediate region 22 are integrally formed. The end regions 21 are disposed at both ends of the conductor 2 in the first direction D1. The end region 21 is a region that includes the fixed part 23, and is fixed to the electrode 120. One fixed part 23 is disposed in one end region 21, and the other fixed part 23 is disposed in the other end region 21. For example, the two end regions 21 are disposed at the same position in the third direction D3.

The intermediate region 22 is a region located between the two end regions 21 in the first direction D1. That is, the two end regions 21 are disposed on both sides in the first direction D1 with the intermediate region 22 interposed therebetween. The intermediate region 22 has a shape that improves the deformability of the conductor 2. More specifically, the intermediate region 22 is bent so as to protrude toward the third direction D3 with respect to the end region 21. The sectional shape of the illustrated intermediate region 22 is a rectangular groove shape.

The intermediate region 22 has a top wall 22a and a pair of side walls 22b. The side walls 22b are erected toward the third direction D3 with respect to the end region 21. The two side walls 22b face each other in the first direction D1. The top wall 22a connects the tip ends of the two side walls 22b. The two side walls 22b and the top wall 22a form a groove that extends in the second direction D2.

The intermediate region 22 has two first bent parts 22c and two second bent parts 22d. The first bent part 22c is formed at the boundary between the side wall 22b and the end region 21. The first bent part 22c is bent so that the side wall 22b is orthogonal to the end region 21. The second bent part 22d is formed at the boundary between the side wall 22b and the top wall 22a. The second bent part 22d is bent so that the top wall 22a is orthogonal to the side wall 22b.

The deformability of the conductor 2 is improved, when the intermediate region 22 is bent or curved so as to protrude toward the third direction D3. When the two electrodes 120 move relative to each other, the conductor 2 can be deformed to follow this relative movement. For example, the relative movement of the electrodes 120 is caused by vibration of the vehicle, thermal expansion of the battery cell 110, and the like. When the two electrodes 120 move relative to each other, the conductor 2 can be deformed to follow the relative movement.

Furthermore, the bus bar 1 of the present embodiment has a plurality of slits 3 that improve the deformability of the conductor 2. The slits 3 are through holes that penetrate through the conductor 2, and have an elongated shape. Each of the slits 3 extends in the first direction D1. In the illustrated conductor 2, each slit 3 is formed to have a certain width. In other words, one slit 3 has an equal width from one end to the other end in the first direction D1.

The slit 3 extends from one end region 21 to the other end region 21, through the intermediate region 22. In other words, each slit 3 has a portion formed in one end region 21, a portion formed in the intermediate region 22, and a portion formed in the other end region 21.

The slits 3 are arranged along the second direction D2 that is orthogonal to the first direction D1. In the illustrated conductor 2, the slits 3 are disposed at equal intervals in the second direction D2. The slits 3 may have the same width. The end part of the slit 3 in the first direction D1 is curved in a circular arc shape. Consequently, the stress concentration at the end part of the slit 3 is reduced.

Between the two fixed parts 23 of the conductor 2, one of the fixed parts 23 is disposed on one side of the slits 3 in the first direction D1. The other fixed part 23 is disposed on the other side of the slits 3 in the first direction D1. Each of the slits 3 is disposed so as not to interfere with the fixed part 23. For example, each slit 3 is disposed outside the welding range 24, separated from the welding range 24.

The slits 3 include a first slit 31 and a second slit 32. The illustrated conductor 2 has four first slits 31 and two second slits 32. Among the slits 3, the second slit 32 is the slit 3 disposed at the end in the second direction D2. The four first slits 31 are disposed between the two second slits 32.

The deformability of the conductor 2 is improved, when the conductor 2 has the slits 3. For example, the slits 3 can improve the deformability of the intermediate region 22. For example, the slits 3 can improve the deformability of the conductor 2 that extends and contracts along the first direction D1. For example, the slits 3 can improve the deformability of the conductor 2 in which the two end regions 21 are moved relative to each other in the third direction D3. The stress caused by the deformation of the conductor 2 is reduced, because the conductor 2 has the slits 3.

In FIG. 4, force F1 and force F2 that apply to the conductor 2 are indicated by arrows. The inventor of the present application found that stress concentration tends to occur at some slits 3, when the conductor 2 is deformed by the force F1 and the force F2. The force F1 and the force F2 are the force that relatively move the two end regions 21 in the second direction D2. The force F1 and the force F2 are applied to the conductor 2, when the two electrodes 120 move relative to each other in the second direction D2.

When the conductor 2 is deformed by the force F1 and the force F2, stress concentration tends to occur at the slit 3 placed away from a virtual line IL. The virtual line IL is a line that connects the two fixed parts 23. The illustrated virtual line IL is a straight line that connects the centers of the two fixed parts 23. For example, the center of the fixed part 23 is the center of the through hole 23a. The virtual line IL in FIG. 4 extends along the first direction D1 at the center position of conductor 2 in the second direction D2.

Stress concentration tends to occur at the end part in the first direction D1, on the slit 3 placed away from the virtual line IL. The reason may be because the distance from a restricted region where deformation is restricted is large. As described above, the fixed part 23 is fixed to the electrode 120 by welding or the like. In the conductor 2, the portion fixed to the electrode 120 is the restricted region where deformation is restricted.

In the conductor 2 in FIG. 4, the slits 3 are disposed on both sides of the virtual line IL in the second direction D2. In this case, among the slits 3, the slits 3 at both ends in the second direction D2 are placed away from the virtual line IL. In other words, the two second slits 32 are the slits 3 that are placed away from the virtual line IL, and at which stress concentration tends to occur.

As will be described below, in the bus bar 1 of the present embodiment, the stress concentration at the second slit 32 is reduced, because length L2 of the second slit 32 is large. First, the stress concentration at the end part of the slit 3 will be described with reference to a comparative example. FIG. 5 illustrates a conductor 200 of the comparative example. In the conductor 200 of the comparative example, the slits 3 have the same length. In other words, the length of slits 39 at both ends is the same as the length of slits 38 disposed therebetween. All the slits 3 are disposed at the same position in the first direction D1.

In the conductor 200 of the comparative example, distance L9 from the fixed part 23 to the slits 39 at both ends is greater than distance L8 from the fixed part 23 to the other slits 38. For example, the distance to each slit 3 is the shortest distance from the center of the fixed part 23 to the end part of the slit 3. At the slits 39 at both ends, stress concentration tends to occur at an end part 39a, because the distance L9 from the fixed part 23 is large.

Moreover, in the conductor 200 of the comparative example, the difference between the distance L8 to the other slits 38 and the distance L9 to the slits 39 at both ends is large. In this case, it is assumed that the difference between the stress generated at the other slits 38 and the stress generated at the slits 39 at both ends is apt to increase.

In the bus bar 1 of the present embodiment, as illustrated in FIG. 2, the length L2 of the second slit 32 is greater than length L1 of the first slit 31. The length L1 or L2 is the length of the slit 3 along the first direction D1. The first slit 31 has an end part 31a in the first direction D1, and the second slit 32 has an end part 32a in the first direction D1. A plurality of the first slits 31 are disposed so that the end parts 31a are aligned in the first direction D1. The end part 32a of the second slit 32 protrudes in the first direction D1 with respect to the first slit 31. In other words, the end part 32a of the second slit 32 is placed further away from the intermediate region 22 than the end part 31a of the first slit 31.

In the bus bar 1 of the present embodiment, the stress concentration at the second slit 32 is reduced, because the second slit 32 is longer than the first slit 31. For example, as illustrated in FIG. 4, in the bus bar 1 of the present embodiment, the distance from the fixed part 23 to the second slit 32 is distance L5. The distance L5 is shorter than the distance L9 in the comparative example. In other words, compared to when the length of the second slit 32 is the same length as that of the first slit 31, the distance L5 from the fixed part 23 to the second slit 32 becomes shorter. That is, in the bus bar 1 of the present embodiment, the end part 32a of the second slit 32 can be brought closer to the fixed part 23. Consequently, the stress concentration at the end part 32a of the second slit 32 is reduced.

Moreover, the length L2 of the second slit 32 relates to the length of a beam 4 formed in the conductor 2. As illustrated in FIG. 4, the slits 3 form a plurality of the beams 4 in the conductor 2. The beam 4 connects one end region 21 with the other end region 21, and extends in the first direction D1. Two adjacent beams 4 are separated by the slit 3.

The beams 4 include a central beam 41, an end beam 42, and a boundary beam 43. The central beam 41 is the beam 4 formed between the two first slits 31. Among the beams 4, the end beam 42 is located at the end part in the second direction D2. The end beam 42 is the beam 4 formed between the second slit 32 and a side 2a of the conductor 2. The side 2a is a side of the end part of the conductor 2 in the second direction, and extends in the first direction D1. The boundary beam 43 is the beam 4 formed between the first slit 31 and the second slit 32.

Each of the beams 4 has length along the first direction D1. In the bus bar 1 of the present embodiment, the length of the end beam 42 is greater than that of the central beam 41. The stress generated on the end beam 42 by the force F1 and F2 is reduced, because the end beam 42 is long. For example, the shear strain at the end beam 42 is reduced, because the end beam 42 is long. Consequently, the stress concentration at the end part 32a of the second slit 32 is reduced. Moreover, because the second slit 32 is longer than the first slit 31, it is assumed that the deformability of the boundary beam 43 becomes greater than the deformability of the central beam 41. Consequently, the stress concentration at the end part 32a of the second slit 32 is reduced.

Furthermore, the end part 32a of the second slit 32 is displaced in the first direction D1, with respect to a connecting line BL that connects the end parts 31a of the first slits 31. The connecting line BL is a straight line that extends in the second direction D2. The stress concentration at the end part 32a is reduced, because the end part 32a of the second slit 32 is displaced with respect to the connecting line BL.

In this manner, in the bus bar 1 of the present embodiment, the stress concentration at the end part 32a of the second slit 32 is reduced, because the length L2 of the second slit 32 away from the virtual line IL is greater than the length L1 of the first slit 31 close to the virtual line IL.

The position of the second slit 32 in the slits 3 is not limited to the position at both ends in the alignment direction. FIG. 6 illustrates another example of the bus bar 1 according to the embodiment. In the bus bar 1 in FIG. 6, the position of the fixed part 23 is shifted to one side of the conductor 2 in the second direction D2. In other words, the fixed part 23 in FIG. 6 is displaced to one side in the second direction D2 with respect to a center line CL of the conductor 2 in the second direction D2. Thus, the virtual line IL that connects the two fixed parts 23 is placed at one side in the second direction D2 with respect to the center line CL of the conductor 2.

The slits 3 of the bus bar 1 illustrated in FIG. 6 include three first slits 31 and three second slits 32. The three first slits 31 are collectively disposed in a region close to the virtual line IL. The three second slits 32 are collectively disposed in a region away from the virtual line IL. For example, the region close to the virtual line IL is a region at the side of the virtual line IL with respect to the center line CL. For example, the region away from the virtual line IL is a region at the side opposite to the virtual line IL with respect to the center line CL.

Each of the first slits 31 has the length L1 in the first direction D1. Each of the second slits 32 has the length L2 in the first direction D1. The length L2 of the second slit 32 is greater than the length L1 of the first slit 31. The stress concentration at the second slit 32 is reduced, because the second slit 32 placed further away from the virtual line IL than the first slit 31 has a relatively large length L2.

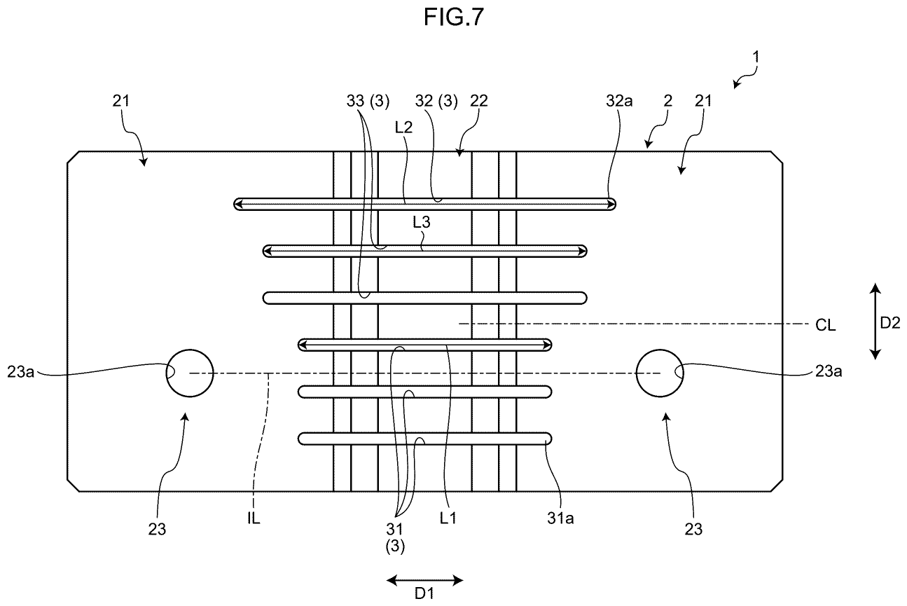

The slits 3 may also have a third slit 33 whose length is different from those of the first slit 31 and the second slit 32. FIG. 7 illustrates another example of the bus bar 1 according to the embodiment. The bus bar 1 in FIG. 7 has the third slit 33 in addition to the first slit 31 and the second slit 32.

The slits 3 of the bus bar 1 illustrated in FIG. 7 include three first slits 31, one second slit 32, and two third slits 33. The three first slits 31 are collectively disposed in a region close to the virtual line IL.

The second slit 32 and the third slit 33 are disposed in a region away from the virtual line IL. The third slit 33 has length L3 in the first direction D1. The length L3 of the third slit 33 is greater than the length L1 of the first slit 31, and is smaller than the length L2 of the second slit 32. That is, the third slit 33 has the length L3 between the length L1 of the first slit 31 and the length L2 of the second slit 32.

Among the slits 3, the second slit 32 is disposed at the position furthest away from the virtual line IL. The third slit 33 is disposed between the three first slits 31 and the second slit 32. The stress concentration at the second slit 32 is reduced, because the length of the second slit 32 furthest away from the virtual line IL is the longest. Moreover, the stress concentration at the third slit 33 is reduced, because the length L3 of the third slit 33 is greater than the length L1 of the first slit 31.

The slits 3 may also include four or more slits 3 whose lengths are different from each other. For example, in FIG. 7, one of the two third slits 33 may be replaced by a fourth slit. For example, the length of the fourth slit is smaller than the length L3 of the third slit 33, and is greater than the length L1 of the first slit 31. In this case, between the two third slits 33, one of the third slits 33 at the side close to the first slit 31 may be replaced by the fourth slit. In the bus bar 1 obtained in this manner, the length of the slit 3 increases from the first slit 31 to the second slit 32, as the slit 3 is placed away from the virtual line IL.

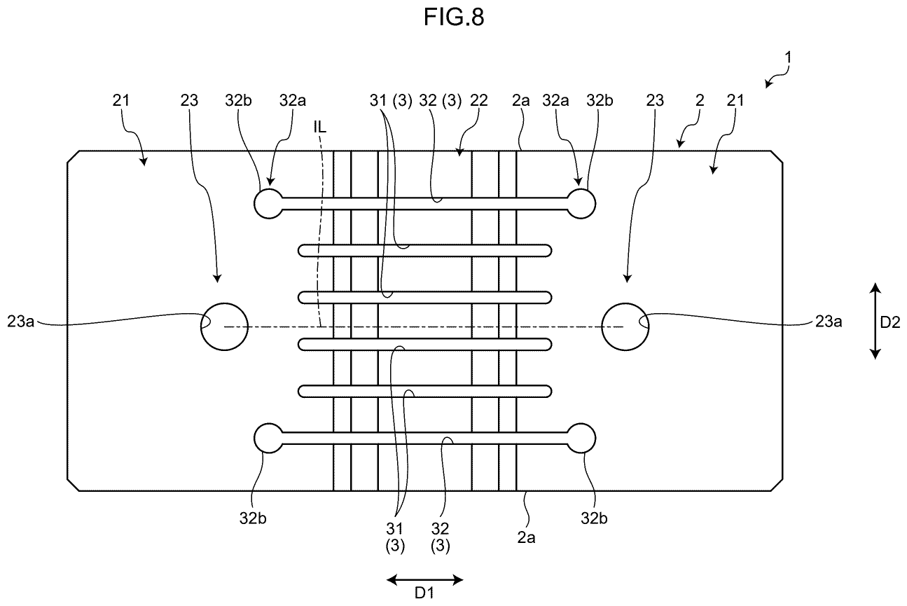

The shape of the end parts 31a and 32a of the slit 3 is not limited to the shape illustrated in FIG. 2 or the like. FIG. 8 illustrates an example of the end shape of the slit 3. In the conductor 2 in FIG. 8, the end part 32a of the second slit 32 has an expanded part 32b. The shape of the expanded part 32b is a circular shape in a plan view. The diameter of the expanded part 32b is greater than the width of the portion of the second slit 32 excluding the expanded part 32b. In the second slit 32 with the expanded part 32b, the stress concentration at the end part 32a is reduced. The end part of the first slit 31 may also have an expanded part similar to the expanded part 32b.

As described above, the bus bar 1 of the present embodiment includes the plate-shaped conductor 2 that connects the electrodes 120 of the two battery cells 110. The conductor 2 has two fixed parts 23 that are each fixed to the electrode 120 of a different battery cell 110, and the slits 3 that extend in the first direction D1. The slits 3 are arranged along the second direction D2 that is orthogonal to the first direction D1. One fixed part 23 is disposed on one side of the slits 3 in the first direction D1. The other fixed part 23 is disposed on the other side of the slits 3 in the first direction D1.

The slits 3 include one first slit 31 and the second slit 32. The second slit 32 is placed further away from the virtual line IL that connects the two fixed parts 23 than the first slit 31. The length L2 of the second slit 32 along the first direction D1 is greater than the length L1 of the first slit 31 along the first direction D1. The stress concentration at the second slit 32 is reduced, because the length L2 of the second slit 32 relatively placed away from the virtual line IL is greater than that of the first slit 31.

The position of the second slit 32 in the slits 3 is not limited to the position furthest away from the virtual line IL. In the conductor 2 illustrated in FIG. 2 or the like, the second slit 32 is placed further away from the virtual line IL than any other slit 3 in the conductor 2. However, the second slit 32 may not be the slit 3 placed furthest away from the virtual line IL. Even if the stress concentration tends to occur with an increase in distance of the slit 3 from the virtual line IL, the position of the slit 3 where the stress concentration most likely occurs may vary depending on the shape of the conductor 2 or the like. In this case, the second slit 32 may be set on the basis of the results of the stress analysis.

Alternatively, by setting the slit 3 at the intermediate position as the second slit 32, the stress applied to the slit 3 further away from the virtual line IL than the second slit 32 may be reduced. Alternatively, the shape of the conductor 2 may restrict the slit 3 furthest away from the virtual line IL from extending in the first direction D1. In this case, the other slit 3 may be set as the second slit 32. Thus, although the position of the second slit 32 among the slits 3 is typically the position furthest away from the virtual line IL, the position may also be set on the basis of other requirements.

In the present embodiment, both ends of the second slit 32 protrude in the first direction D1 with respect to the first slit 31. Consequently, the stress concentration at the end parts 32a at both sides of the second slit 32 is reduced, because the end parts 32a become close to the fixed part 23.

For example, among the slits 3, the second slit 32 is placed furthest away from the virtual line IL. The stress concentration is reduced, because the length L2 of the second slit 32 placed furthest away is large.

The conductor 2 of the present embodiment includes two flat-shaped end regions 21 disposed at both ends in the first direction D1, and the intermediate region 22 between the two end regions 21. The intermediate region 22 is bent so as to protrude toward the third direction D3 that is orthogonal to the first direction D1 and the second direction D2 with respect to the end region 21. One fixed part 23 is disposed in one end region 21, and the other fixed part 23 is disposed in the other end region 21. Each of the slits 3 extends from one end region 21 to the other end region 21, through the intermediate region 22. The conductor 2 with such an intermediate region 22 has a high following ability with respect to the relative movement of the electrode 120.

In the bus bar 1 of the present embodiment, the slits 3 form the beams 4 that extend in the first direction D1 on the conductor 2. The beams 4 have the end beam 42 in the second direction D2. The end beam 42 is formed between the second slit 32 and the side 2a of the conductor 2, and is longer than the other beams 4. For example, in the bus bar 1 in FIG. 4, the two end beams 42 are longer than the other beams 4. More specifically, the end beam 42 is longer than any of the beams 4 among the beams 4 excluding the end beam 42. In other words, the end beam 42 is longer than the central beam 41, and is longer than the boundary beam 43. The stress concentration at the second slit 32 is reduced, because the end beam 42 has the longest length along the first direction D1.

The means of fixing the fixed part 23 to the electrode 120 is not limited to welding. For example, the fixed part 23 may be joined to the electrode 120 by means other than welding. The fixed part 23 may also be fixed to the electrode 120 by a fastening member such as a nut.

In the conductor 2, the shape of the intermediate region 22 is not limited to the illustrated shape. For example, the sectional shape of the intermediate region 22 may be a shape curved in a circular arc, curved in a U-shape, a V-shape, or any other shape.

The shape of the intermediate region 22 is not limited to the shape protruding in the third direction D3. For example, the shape of the intermediate region 22 may also be a flat plate shape that is not protruding in the third direction D3. In this case, the conductor 2 may also have a flat plate shape that is flat from one end region 21 to the other end region 21.

The contents disclosed in the embodiment described above may be implemented in appropriate combination.

In the bus bar according to the present embodiment, the plurality of slits include one first slit, and the second slit placed further away from the virtual line that connects the two fixed parts than the first slit. The length of the second slit along the first direction is greater than the length of the first slit along the first direction. The bus bar according to the present embodiment can advantageously reduce the stress concentration at the second slit away from the virtual line.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A bus bar, comprising:
a plate-shaped conductor that connects electrodes of two battery cells, wherein
the conductor has two fixed parts each fixed to the electrode of a different battery cell, and a plurality of slits that extend in a first direction,
the slits are arranged along a second direction orthogonal to the first direction,
one of the fixed parts is disposed on one side in the first direction with respect to the slits,
another fixed part is disposed on another side in the first direction with respect to the slits,
the slits include one first slit, and a second slit placed further away from a virtual line that connects the two fixed parts than the first slit, and
length of the second slit along the first direction is greater than length of the first slit along the first direction.

2. The bus bar according to claim 1, wherein both ends of the second slit protrude in the first direction with respect to the first slit.

3. The bus bar according to claim 1, wherein among the slits, the second slit is placed furthest away from the virtual line.

4. The bus bar according to claim 1, wherein
the conductor has two flat-shaped end regions disposed at both ends in the first direction, and an intermediate region between the two end regions,
the intermediate region is bent so as to protrude toward a third direction that is orthogonal to the first direction and the second direction with respect to the end region,
one of the fixed parts is disposed in one of the end regions, and the other fixed part is disposed in the other end region, and
each of the slits extends from one of the end regions to the other end region, through the intermediate region.

5. The bus bar according to claim 1, wherein
the slits form a plurality of beams that extend in the first direction in the conductor,
the beams have an end beam in the second direction, and
the end beam is formed between the second slit and a side of the conductor, and is longer than the other beam.
